(19) United States
(12) Patent Application Publication
(10) Pub. No.: US 2025/0259637 A1
(43) Pub. Date: Aug. 14, 2025

(54) ELECTRONIC DEVICE AND METHOD FOR PROCESSING AUDIO SIGNAL

(71) Applicant: Samsung Electronics Co., Ltd., Suwon-si (KR)

(72) Inventors: Hyunchul YANG, Suwon-si (KR); Hyunwook KIM, Suwon-si (KR); Hangil MOON, Suwon-si (KR); Jaeha PARK, Suwon-si (KR); Kyoungho BANG, Suwon-si (KR); Sanghoon LEE, Suwon-si (KR); Seung HEO, Suwon-si (KR)

(21) Appl. No.: 19/097,024

(22) Filed: Apr. 1, 2025

Related U.S. Application Data
(63) Continuation of application No. PCT/KR2023/015590, filed on Oct. 11, 2023.

(30) Foreign Application Priority Data
Oct. 14, 2022 (KR) 10-2022-0132769
Nov. 28, 2022 (KR) 10-2022-0161912

(51) Int. Cl. G10L 19/032

(52) U.S. Cl. CPC G10L 19/032

(57) ABSTRACT

A method for controlling an electronic device is provided. The control method includes obtaining a quantization bit number for each division audible frequency band dividing an audible frequency band based on the preset user's hearing characteristic, performing quantization using a quantization bit number corresponding to an audio signal, for each division audible frequency band extracted from an audio signal output by reproduction of audio content, and generating an audio signal quantized for each division audible frequency band as a bitstream and transmitting the bitstream to an external electronic device through a radio channel.

### CROSS-REFERENCE TO RELATED APPLICATION(S)

This application is a continuation application, claiming priority under 35 U.S.C. § 365(c), of an International application No. PCT/KR2023/015590, filed on Oct. 11, 2023, which is based on and claims the benefit of a Korean patent application number 10-2022-0132769, filed on Oct. 14, 2022, in the Korean Intellectual Property Office, and of a Korean patent application number 10-2022-0161912, filed on Nov. 28, 2022, in the Korean Intellectual Property Office, the disclosure of each of which is incorporated by reference herein in its entirety.

### BACKGROUND

### 1. Field

The disclosure relates to an electronic device and a method for processing audio signals through quantization or inverse quantization.

### 2. Description of Related Art

Electronic devices (e.g., computers, portable terminals, tablets, or the like) may be connected to external electronic devices, such as wireless earphones (e.g., true wireless stereo (TWS)) using short-range wireless communication schemes, such as Bluetooth schemes. An electronic device may transmit content data, such as audio signals, to an external electronic device connected using a wireless communication scheme. An electronic device may experience delays or corruption of content data, such as transmitted audio signals, due to the distance from wireless earphones, channel congestion, or unexpected interference. The electronic device need to compress and transmit data using a specific encoding scheme to prevent data from being damaged during the process of transferring the transmission data to a wireless earphone which is an external electronic device. The wireless earphone, which is an external electronic device, may reconstruct the compressed data using a specific decoding scheme corresponding to the encoding scheme used by the counterpart electronic device.

In short-range communication schemes, such as Bluetooth, transmission performance may be proportional to the amount of data encoded by the electronic device. A large amount of encoded data in an electronic device may mean that a lot of information may be transferred to the wireless earphone, which is an external electronic device, to provide a high-quality service. However, as the amount of data to be transmitted increases, traffic on the radio channel connecting the electronic device and the wireless earphone which is an external electronic device may increase.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for performing an encoding or decoding operation on audio signals by reflecting a user's hearing characteristics.

Additional aspects will be set forth in part in the description which follows and, in part, will be apparent from the description, or may be learned by practice of the presented embodiments.

In accordance with an aspect of the disclosure, a method for controlling an electronic device is provided. The method includes obtaining a quantization bit number for each division audible frequency band dividing an audible frequency band based on a preset user's hearing characteristic, performing quantization using a quantization bit number corresponding to an audio signal for each division audible frequency band extracted from an audio signal output by reproduction of an audio content, and generating an audio signal quantized for each division audible frequency band as a bitstream and transmitting the bitstream to an external electronic device through a radio channel.

In accordance with another aspect of the disclosure, a method for controlling an electronic device is provided. The method includes analyzing a bitstream received from an external electronic device, obtaining an inverse-quantization bit number for each division audible frequency band included in the bitstream, performing inverse-quantization on the bitstream for each audible frequency band using the inverse-quantization bit number, and outputting an audio signal generated by the inverse-quantization.

In accordance with another aspect of the disclosure, an electronic device for transmitting an audio signal is provided. The electronic device includes a communication module, memory storing one or more computer programs, and one or more processors communicatively coupled to the communication module and the memory, wherein the one or more computer programs include computer-executable instructions that, when executed by the one or more processors individually or collectively, cause the electronic device to obtain a quantization bit number for each division audible frequency band dividing an audible frequency band based on a preset user's hearing characteristic, perform quantization using a quantization bit number corresponding to an audio signal for each division audible frequency band extracted from an audio signal output by reproduction of an audio content, and generate an audio signal quantized for each division audible frequency band as one bitstream and transmit the bitstream to an external electronic device through a radio channel.

In accordance with another aspect of the disclosure, an electronic device is provided. The electronic device includes a communication module, memory storing one or more computer programs, and one or more processors communicatively coupled to the communication module and the memory, wherein the one or more computer programs include computer-executable instructions that, when executed by the one or more processors individually or collectively, cause the electronic device to analyze a bitstream received from an external electronic device, obtain an inverse-quantization bit number for each division audible frequency band included in the bitstream, perform inverse-quantization on the bitstream for each audible frequency band using the inverse-quantization bit number, and output an audio signal generated by the inverse-quantization.

In accordance with another aspect of the disclosure, one or more non-transitory computer-readable storage media storing one or more programs including computer-executable instructions that, when executed by one or more processors of an electronic device individually or collectively, cause the electronic device to perform operations are provided. The operations include obtaining a quantization bit number for each division audible frequency band dividing an audible frequency band based on a preset user's hearing characteristic, performing quantization using a quantization bit number corresponding to an audio signal for each division audible frequency band extracted from an audio signal output by reproduction of an audio content, and generating an audio signal quantized for each division audible frequency band as a bitstream and transmitting the bitstream to an external electronic device through a radio channel.

According to an embodiment of the disclosure, it is possible to increase the satisfaction of the user listening to audio signals by wireless earphones without increasing the amount of data by applying a different coding rate to each of division frequency bands obtained by dividing an audible frequency band, which is an audio signal, into a plurality of audible frequency bands considering the user's hearing characteristics.

Other aspects, advantages and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a block diagram illustrating an audio module according to an embodiment of the disclosure;

FIG. 3 is a block diagram illustrating a first electronic device according to an embodiment of the disclosure;

FIG. 4 is a flowchart illustrating an operation of quantizing an audio signal by a first electronic device according to an embodiment of the disclosure;

FIG. 5 is a flowchart illustrating control for quantizing an audio signal by a first electronic device according to an embodiment of the disclosure;

FIG. 6 is a block diagram illustrating a second electronic device according to an embodiment of the disclosure;

FIG. 7 is a flowchart illustrating an operation of inverse-quantizing an audio signal by a second electronic device according to an embodiment of the disclosure;

FIG. 8 is a flowchart illustrating control for inverse-quantizing an audio signal by a second electronic device according to an embodiment of the disclosure;

FIG. 9 is a block diagram illustrating an encoder of a first electronic device according to an embodiment of the disclosure;

FIG. 10 is a block diagram illustrating part of an encoder of a first electronic device according to an embodiment of the disclosure; and

FIG. 11 is a block diagram illustrating a decoder of a second electronic device according to an embodiment of the disclosure.

Throughout the drawings, like reference numerals will be understood to refer to like parts, components, and structures.

### DETAILED DESCRIPTION

The following description with reference to the accompanying drawings provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

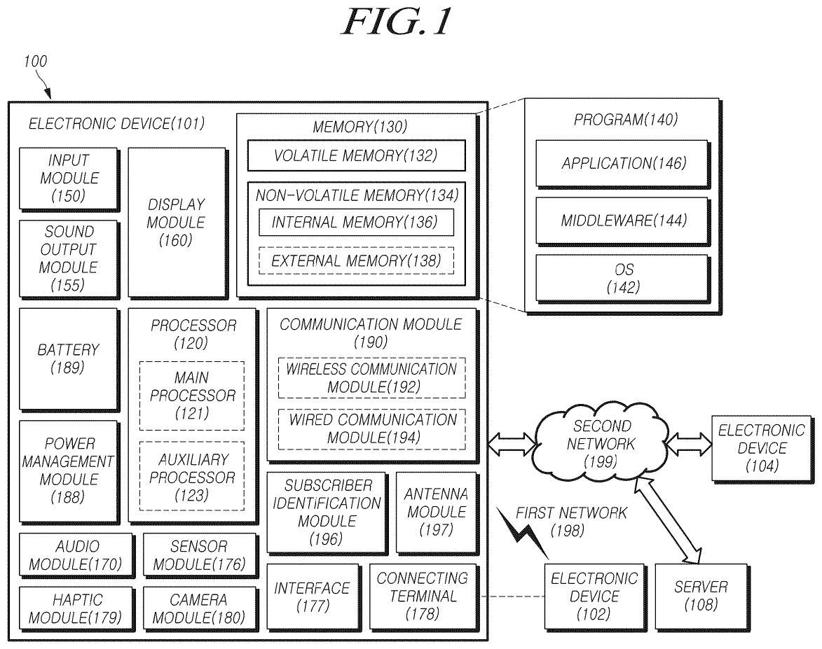

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the electronic device 104 via the server 108. According to an embodiment of the disclosure, the external electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In a process in which the electronic device 101 compresses an audio signal, the audio signal to be compressed may be quantized. Quantization is a process of dividing the actual value of the audio signal at regular intervals. In other words, quantization is to represent the size of the waveform of the audio signal at several quantization steps (quantization levels) of predetermined quantization intervals.

If the quantization interval is too wide, noise due to quantization may occur, which is called quantization noise. If the quantization noise increases, the sound quality of the audio signal felt by the user may deteriorate. Conversely, if the quantization noise is too narrow, the quantization noise may decrease, but the number of segments of the audio signal that should be represented after quantization processing increases, increasing the bitrate required for encoding, and thus increasing the amount of data to be transmitted per unit time.

Therefore, it is required to find the optimal quantization interval not to increase the bitrate while minimizing the deterioration of the audio signal due to quantization noise.

During quantization, a different quantization interval may be determined for each frequency. According to a typical psychoacoustical model, most users are often sensitive to relatively low frequency bands of the audible frequency band (e.g., 250 Hz to 8000 Hz), so bits may be allocated to low frequency bands at narrow quantization intervals.

According to an example, a source electronic device (e.g., the electronic device 101 of FIG. 1) (hereinafter, referred to as a ‘source electronic device 101’ or a ‘first electronic device 101’) may provide audio data to an external electronic device (e.g., the external electronic device 102 of FIG. 1) (hereinafter, referred to as an ‘external electronic device 102,’ ‘consumption electronic device 102’ or a ‘second electronic device 102’). The second electronic device 102 may process the audio data provided from the first electronic device 101 to output an audio signal that is an audible signal. The second electronic device 102 may be an audio output device capable of outputting an audio signal. The audio output device may be, e.g., an electronic device, such as a wireless earphone or a Bluetooth speaker.

For example, the electronic device 101 may perform signal processing for providing an audio signal in an audible frequency band (e.g., 250 Hz to 8000 Hz) to the second electronic device 102. The electronic device 101 may compress audio data recorded in an internal or external memory 130 in digital form using a predetermined encoding scheme to transfer the audio data to the external electronic device 102, such as a wireless earphone. The first electronic device 101 may output a bitstream in which the audio signal is compressed using a predetermined encoding scheme.

More specifically, the first electronic device 101 may use hearing characteristic information to encode an audio signal to be transferred to the second electronic device 102. The hearing characteristic information may be information collected through a hearing test for the user. For example, the hearing characteristic information may be information in which an audible frequency band is divided into a plurality of frequency bands and the user's hearing ability is defined for each of the divided frequency bands (hereinafter, referred to as a “division audible frequency band”). In this case, the hearing characteristic information may define a frequency band to which the user reacts sensitively and a frequency band to which the user does not react relatively sensitively. That the user sensitively reacts may mean that the user may hear well an audio signal in a specific frequency band at a relatively low decibel (e.g., an audio signal in a small volume) or the probability that the user may recognize relatively low contamination or corruption is high. That the user insensitively reacts may mean that the user may hear well an audio signal in the corresponding frequency band at a relatively high decibel (e.g., an audio signal in a large volume) or the probability that the user may recognize relatively high contamination or corruption is low.

For example, the first electronic device 101 may divide the audio signal in the audible frequency band into a plurality of division audible frequency bands and determine a quantization bit number to be used to perform quantization for each of the divided audio signals (hereinafter, referred to as ‘division audio signals’) considering the hearing characteristic information. The first electronic device 101 may perform quantization for each division audio signal using the quantization bit number determined for each division audible frequency band. The first electronic device 101 may configure the bit strings quantized for each division audible frequency band as one bitstream and transmit the bitstream to the second electronic device 102. For example, the bitstream may be generated by sequentially arranging quantization bit strings (hereinafter referred to as ‘division quantization bit strings’) generated for each division audible frequency band in the order of generation.

The bitstream may be filled with one or more padding bits between the quantization bit strings, e.g., to distinguish two consecutive quantization bit strings. To that end, the first electronic device 101 and the second electronic device 102 may perform a synchronization procedure for unifying whether to use the padding bits or the types of the padding bits in advance. The padding bit may make it easy for the second electronic device 102 to separate quantization bit strings for each division audible frequency band from the bitstream.

For example, the bitstream may include information to be referenced (hereinafter referred to as ‘meta information’) to reconstruct division quantization bit strings included in the bitstream. The meta information may include information that may be considered by the second electronic device 102 to allocate the quantization bit number for each of the division quantization bit strings included in the bitstream. For example, the meta information may include a quantization division identifier indicating whether quantization has been performed considering the hearing characteristics of the user. For example, the meta information may include information about a quantization bit allocation table referenced to allocate the quantization bit number for quantization. The information about the quantization bit allocation table may include, e.g., a table identifier indicating a quantization allocation table actually used for quantization among the quantization bit allocation tables synchronized between the first electronic device 101 and the second electronic device 102. The information about the quantization bit allocation table may include, e.g., information constituting a quantization allocation table actually used by the first electronic device 101 to allocate the quantization bit number for quantization.

As an example, the second electronic device 102 may receive a bitstream corresponding to the audio content from the first electronic device 101. The second electronic device 102 may obtain the meta information included in the bitstream. The second electronic device 102 may determine an inverse-quantization bit allocation table by the meta information. For example, the second electronic device 102 may generate or select an inverse-quantization bit allocation table reflecting the hearing characteristics of the user by meta information for quantization.

The second electronic device 102 may determine the inverse-quantization bit number for each division quantization bit string included in the bitstream received from the first electronic device 101 using the inverse-quantization bit allocation table. The second electronic device 102 may perform inverse-quantization on the division quantization bit string using the determined inverse-quantization bit number. The second electronic device 102 may perform a restoration procedure including inverse-quantization for each division audible frequency band to merge the reconstructed audio signals for each division audible frequency band to generate and output a single audio signal.

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

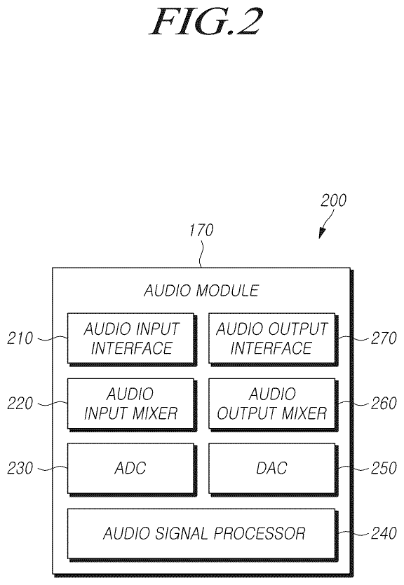

FIG. 2 is a block diagram 200 illustrating an audio module according to an embodiment of the disclosure.

Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input device 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment of the disclosure, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment of the disclosure, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment of the disclosure, the audio input mixer 220 may synthesize a plurality of analog audio signals inputted via the audio input interface 210 into at least one analog audio signal.

The ADC 230 may convert an analog audio signal into a digital audio signal. For example, according to an embodiment of the disclosure, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment of the disclosure, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment of the disclosure, one or more functions of the audio signal processor 240 may be implemented in the form of an equalizer.

The DAC 250 may convert a digital audio signal into an analog audio signal. For example, according to an embodiment of the disclosure, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be outputted, into at least one audio signal. For example, according to an embodiment of the disclosure, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output device 155. The sound output device 155 may include, for example, a speaker, such as a dynamic driver or a balanced armature driver, or a receiver. According to an embodiment of the disclosure, the sound output device 155 may include a plurality of speakers. In such a case, the audio output interface 270 may output audio signals having a plurality of different channels (e.g., stereo channels or 5.1 channels) via at least some of the plurality of speakers. According to an embodiment of the disclosure, the audio output interface 270 may be connected with the external electronic device 102 (e.g., an external speaker or a headset) directly via the connecting terminal 178 or wirelessly via the wireless communication module 192 to output an audio signal.

According to an embodiment of the disclosure, the audio module 170 may generate, without separately including the audio input mixer 220 or the audio output mixer 260, at least one digital audio signal by synthesizing a plurality of digital audio signals using at least one function of the audio signal processor 240.

According to an embodiment of the disclosure, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment of the disclosure, the audio amplifier may be configured as a module separate from the audio module 170.

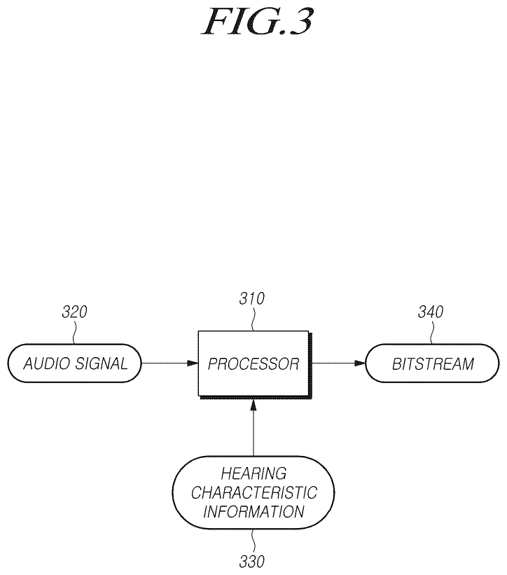

FIG. 3 is a block diagram illustrating a source electronic device according to an embodiment of the disclosure.

Referring to FIG. 3, at least one processor 310 (e.g., the processor 120 of FIG. 1) included in the first electronic device (or source electronic device) 101 may generate or output a bitstream 340 by encoding (or compressing) an audio signal 320. The processor 310 may use the hearing characteristic information 330 when encoding the audio signal 320.

According to an example, the processor 310 may receive the audio signal 320 in the audible frequency band through internal memory (e.g., the memory 130 of FIG. 1), external memory connected to an interface (e.g., the interface 177 of FIG. 1), or a communication network (e.g., the first network 198 of FIG. 1 or the second network 199 of FIG. 1). The audio signal 320 may be, e.g., an electrical signal generated by execution of a music player. The audio signal 320 may be a digital audio signal. The audio signal 320 may be, e.g., a signal modulated by a pulse code modulation (PCM) scheme.

The processor 310 may include, e.g., a main processor (e.g., the main processor 121 of FIG. 1) or an auxiliary processor (e.g., the auxiliary processor 123 of FIG. 1). The processor 310 may perform compression by, e.g., an encoding operation on the input audio signal 320. The compression may be performed software-wise in the processor 310 or hardware-wise through a separate encoder unit.

The audio signal 320 may be encoded by the main processor 121 or the auxiliary processor 123. The audio signal 320 may be encoded in a legacy mode in the main processor 121, for example. The audio signal 320 may be encoded, e.g., in a separate communication chip provided in the auxiliary processor 123. Encoding of a low-power mode audio signal may be performed in a separate communication chip of the auxiliary processor 123. The user may select to compress the audio signal 320 by at least one of the main processor 121 or the auxiliary processor 123.

The hearing characteristic information 330 may be, e.g., information reflecting the hearing characteristics of the user. The hearing characteristic information 330 may be, e.g., information indicating the frequency band of sound to which the user is sensitive in the audible frequency band. The hearing characteristic information 330 may be, e.g., information indicating whether each user is more or less sensitive to a specific frequency. The hearing characteristic information 330 may be measured differently according to, e.g., the left ear or the right ear of the same user. The hearing characteristic information 330 may be measured differently according to the age of the user.

For the hearing characteristic information 330, hearing measurement may be performed by, e.g., an application (e.g., the application 146 of FIG. 1) stored in the memory (e.g., the memory 130 of FIG. 1) of the first electronic device 101. An application that measures the user's hearing characteristics may be referred to as a ‘hearing test app’.

If the user executes the hearing test app, a voice signal in a specific frequency band may be output to the second electronic device (or external electronic device) 102 connected to the first electronic device 101. The second electronic device 102 may be, e.g., a sound output device, such as an earphone. The first electronic device 101 and the second electronic device 102 may be wiredly or wirelessly connected. The first electronic device 101 may be wiredly connected to the second electronic device 102 through a connection terminal (e.g., the connection terminal 178 of FIG. 1) provided therein. The first electronic device 101 may be wirelessly connected to the second electronic device 102 through, e.g., a Bluetooth scheme.

If the user executes the hearing test app, the hearing test app may transmit a voice signal in a specific frequency band transmitted from the first electronic device 101 to the sound output device of the second electronic device 102 connected to the first electronic device 101. The voice signal in the specific frequency band transmitted from the hearing test app may be referred to as a test signal. The test signal may be output a plurality of times, e.g., continuously or at predetermined time intervals. For example, the sound volume of the test signal may gradually decrease over time. The first electronic device 101 may reduce the decibel (dB) of the test signal over time and output the same. The user may determine whether the test signal output from the sound output device of the second electronic device 102 is heard. If it is determined that the test signal is not heard, the user may touch a button displayed at a predetermined position on the display (e.g., the display module 160 of FIG. 1) of the first electronic device 101. The first electronic device 101 may record the time required for the user to touch the button.

In the hearing test app, the test may be repeated for each division audible frequency band obtained by dividing the specific frequency band by predetermined intervals. The predetermined intervals may be, e.g., intervals obtained by dividing an audible frequency band between 250 Hz and 8000 Hz by n. When the audible frequency band is divided into predetermined intervals, each division audible frequency band may be referred to as a subband (Sb). Hereinafter, for convenience of description, the division audible frequency band is referred to as a subband.

For example, if the audible frequency band is divided into 12 subbands, the subbands may be referred to as a first subband Sb #1, a second subband Sb #2, . . . , an eleventh subband Sb #11 or a twelfth subband Sb #12 in the order from the lowest frequency band to the highest frequency band. The respective intervals of the subbands may be the same or different. According to the time required for the user to determine that the voice signal in the specific frequency band is not heard, the first electronic device 101 may record the user's hearing measurement result in each subband. The hearing measurement result may be recorded in three stages, e.g., very good, good, and average.

For example, if the user determines that the test signal is not heard after 5 seconds in each subband and clicks a button displayed on the display module 160, the first electronic device 101 may predict that the user may hear a relatively low decibel sound in the corresponding subband. In this case, the first electronic device 101 may record the hearing measurement result in the subband as ‘very good’.

For example, if the user determines that the test signal is not heard after 3 seconds in a specific subband and clicks a button displayed on the display module 160, the first electronic device 101 may predict that the user may hear a sound in such a decibel that an average person may hear in the corresponding subband. In this case, the first electronic device 101 may record the hearing measurement result in the subband as ‘good’.

For example, if the user determines that the test signal is not heard after one second in a specific subband and clicks a button displayed on the display module 160, the first electronic device 101 may predict that the user may hear only a relatively high decibel sound in the corresponding subband. In this case, the first electronic device 101 may record the hearing measurement result in the subband as ‘average’. However, without limitations thereto, if necessary, the first electronic device 101 may subdivide and record the hearing measurement result or set different hearing measurement schemes.

The hearing measurement result measured by the hearing test app may be stored in the memory 130 in the form of a database (DB). The user may additionally perform hearing measurement using the hearing test app. The additional hearing measurement result of the user may be stored in the memory 130 in the form of the database. If hearing measurement results through a plurality of hearing measurements are stored in a database, the processor 120 may store an average value of the plurality of obtained hearing measurement results in the database. The average value of the plurality of stored hearing measurement results may be stored as hearing characteristic information 330 of the user. However, without limitations thereto, the hearing measurement result according to the hearing measurement test recently performed by the user may be stored as hearing characteristic information 330 of the user.

For example, the user may include information about a value arbitrarily input for hearing for each frequency band. In addition to the hearing measurement result measured by executing the hearing test app by the user, the processor 310 may store information about hearing for each frequency band input by the user as hearing characteristic information 330.

The stored hearing characteristic information 330 of the user may be referred to as hearing data.

The processor 310 may perform a compression process (or encoding process) on the input audio signal 320. In performing the compression process, the processor 310 may use the hearing data stored in the memory 130. The compression process may include an operation of quantizing the input audio signal 320. The quantization operation may include an operation of allocating the quantization bit number for performing quantization for each subband. The operation of allocating the quantization bit number may include an operation of determining a bit allocation table. The bit allocation table may define information about the quantization bit number to be allocated for each subband. The operation of allocating the quantization bit number may include an operation in which the processor 310 determines the presence or absence of the hearing data stored in the memory 130 and selects or generates a bit allocation table accordingly. The processor 310 may determine the quantization bit number corresponding to the audio signal for each subband using the bit allocation table.

For example, if there is hearing data, the processor 310 may select or generate a bit assignment table reflecting the hearing data. The bit allocation table reflecting the hearing data may, e.g., allocate a relatively large bit number to a subband to which the user sensitively responds to and a relatively small bit number to a subband to which the user insensitively responds. The bit allocation table reflecting the hearing data may be referred to as a ‘characteristic bit allocation table (attribute bit allocation table)’. The processor 310 may perform quantization on the audio signal using the characteristic bit allocation table. Hereinafter, the characteristic bit allocation table is referred to as a ‘first bit allocation table’.

For example, if there is no hearing data, the processor 310 may select or generate a standard bit allocation table (normalized bit allocation table) without considering hearing data. The standard bit allocation table may exist in the memory 130 in the form of a database, for example. The standard bit allocation table may be, e.g., a bit allocation table considering psychoacoustics. The standard bit allocation table may, e.g., allocate a relatively large quantization bit number to subbands to which many people sensitively react statistically and a relatively small quantization bit number to subbands to which they insensitively react. Statistically, many unspecified people often react to low-band subbands sensitively, so that the standard bit allocation table may be provided to allocate a relatively large quantization bit number to low-band subbands. However, without limitations thereto, the standard bit allocation table may be, e.g., a table in which a relatively large number of bits are allocated to subbands in a mid- or high-band rather than a low-band according to the characteristics of samples for generating the standard bit allocation table. Hereinafter, the standard bit allocation table is referred to as a ‘second bit allocation table’.

The processor 310 may generate and output a bitstream 340 as a result of performing a compression process on the input audio signal 320. The processor 310 may transmit the bitstream 340 to the second electronic device 102 through a communication module (e.g., the communication module 190 of FIG. 1). The bitstream 340 may be transmitted to the second electronic device 102 through, e.g., a Bluetooth scheme. The bitstream may be transmitted to the second electronic device 102 via, e.g., an advanced audio distribution profile (A2DP).

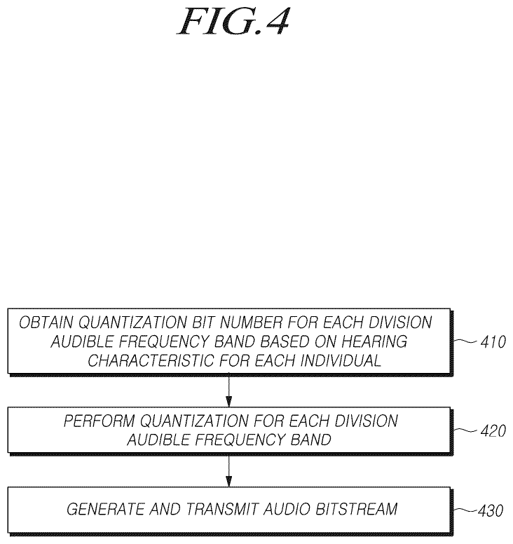

FIG. 4 is a flowchart illustrating an operation in which a first electronic device quantizes an audio signal according to an embodiment of the disclosure.

Referring to FIG. 4, in operation 410, the first electronic device 101 may obtain a quantization bit number based on hearing characteristics for each division audible frequency band. The division audible frequency band may mean, e.g., a specific frequency band obtained by dividing the audible frequency band by a predetermined number. The division audible frequency band may also be referred to as a subband.

The first electronic device 101 may perform quantization using the first bit allocation table according to hearing characteristics (e.g., the hearing characteristic information 330 of FIG. 3 or the hearing data of FIG. 3) to obtain the quantization bit number based on hearing characteristics. The first allocation bit table may be, e.g., a table for the quantization bit number to be performed by reflecting hearing characteristics for each division audible frequency.

The first electronic device 101 may perform quantization for each division audible frequency band using the second bit allocation table, which is a standard bit allocation table irrelevant to hearing characteristics.

The first electronic device 101 may obtain the quantization bit number to perform quantization for each division audible frequency using either the first bit allocation table or the second bit allocation table.

In operation 420, the first electronic device 101 may perform quantization using the quantization bit number corresponding to the division audio signal, which is an audio signal for each division audible frequency band. The quantization bit number may mean the quantization bit number for each division audible frequency obtained by the first bit allocation table or the second bit allocation table generated in operation 410. The first electronic device 101 may perform quantization on the division audio signal according to the quantization bit number, for example.

In operation 430, the first electronic device 101 may generate a quantized audio signal as a bitstream. The first electronic device 101 may transmit the bitstream to the second electronic device 102. As a result of the quantization performed by the first electronic device 101 in operation 420, a bitstream may be generated. The first electronic device 101 may establish a radio channel to connect the second electronic device 102 to transmit the generated bitstream. The first electronic device 101 may transmit the bitstream to the second electronic device 102 through the radio channel.

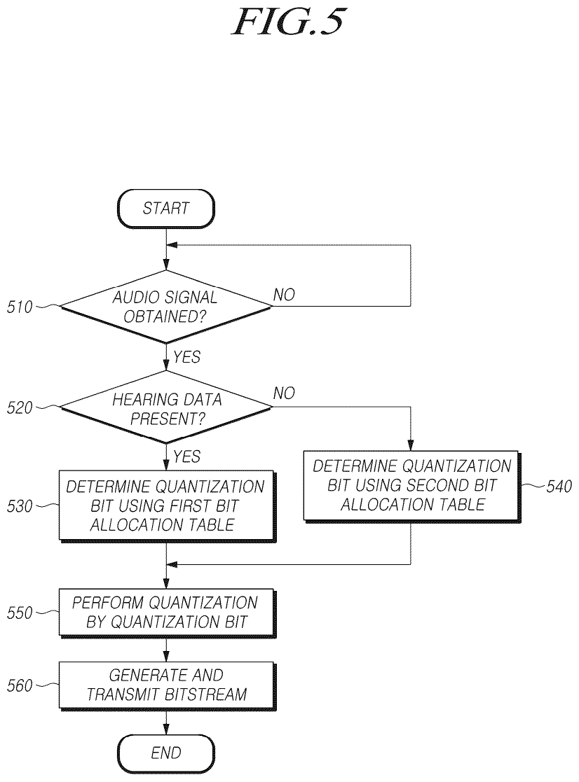

FIG. 5 is a flowchart illustrating control for quantizing an audio signal by a first electronic device according to an embodiment of the disclosure.

Referring to FIG. 5, in operation 510, the first electronic device 101 may receive an audio signal. The audio signal may be, e.g., an audio signal generated by execution of a music player. The audio signal may include a digital audio signal. The audio signal may be an audio signal modulated by a pulse code scheme.

In operation 520, the first electronic device 101 may determine whether hearing data is present. The hearing data may be, e.g., hearing characteristic information about the user measured by a hearing measurement app of the first electronic device 101. The hearing data may be, e.g., hearing characteristic information arbitrarily input by the user without measuring by the hearing measurement app. The hearing data may be, e.g., information indicating the subband of sound to which the user is sensitive in the audible frequency band. The hearing data may be any one of an average value of results measured by the hearing measurement app or a result measured by the user using the hearing measurement app most recently.

If hearing data is present, the first electronic device 101 may, in operation 530, select or generate a first bit allocation table. The first bit allocation table may be, e.g., a bit allocation table reflecting the hearing characteristics of the user. The first bit allocation table may be a bit allocation table where the user allocates a relatively large number of bits to a sensitive subband. The first bit allocation table may be, e.g., the values of the results of deriving bits to be applicated to each subband through computation with predetermined weights for each subband in which the user's hearing has been measured.

Although not illustrated, the first electronic device 101 may analyze the hearing data. For example, the first electronic device 101 may analyze the bands to which the user is sensitive among the division audible frequency bands in relation to the user's hearing characteristics indicated by the hearing data.

For example, if the first electronic device 101 obtains a result that the user is sensitive to a low-band audio signal among the division audible frequency bands as a result of analyzing the hearing data, the first electronic device 101 may select the second bit allocation table stored in the memory 130. The second bit allocation table may mean, e.g., the standard bit allocation table of FIG. 3. Accordingly, since the first electronic device 101 does not need to select or generate a first bit allocation table reflecting hearing data, the computation efficiency or transmission efficiency may be increased.

Although not illustrated, the first electronic device 101 may compare the first bit allocation table and the second bit allocation table and then determine which bit allocation table is to be used to perform quantization.

For example, a characteristic bit allocation table generated based on hearing data of the user sensitive to a low-band may be substantially the same as the standard bit allocation table. The first electronic device 101 may compare, e.g., allocation bits for each subband of the characteristic bit allocation table and allocation bits for each subband of the standard bit allocation table. The first electronic device 101 may compare, e.g., a predetermined weight for each subband according to the user's hearing data with a predetermined weight used to generate the standard bit allocation table.

The first electronic device 101 may determine whether there is a substantial difference between the first bit allocation table that is the characteristic bit allocation table and the second bit allocation table that is the standard bit allocation table. If there is a substantial difference between the first bit allocation table and the second bit allocation table, the first electronic device 101 may determine quantization bits using the first bit allocation table in operation 530.

If there is no hearing data in the first electronic device 101 or there is no substantial difference between the first bit allocation table and the second bit allocation table, the electronic device 101 may determine the quantization bits by selecting the second bit allocation table in operation 540. Even if the hearing data is present, if the first electronic device 101 analyzes that the hearing data is sensitive to a low-band division audible band, the first electronic device 101 may perform quantization by selecting the second bit allocation table considering computation efficiency or transmission efficiency. The second bit allocation table may be the standard bit allocation table which does not reflect individual hearing characteristics of the user.

In operation 550, the first electronic device 101 may compress each division audio signal using the quantization bit number determined for each division audible frequency band. For example, if the first electronic device 101 quantizes each division audio signal using the first bit allocation table, a relatively large number of quantization bit strings may be generated in subbands (e.g., mid-band or high-band subbands) to which the user sensitively reacts. For example, if the first electronic device 101 quantizes each division audio signal using the second bit allocation table, a relatively large number of quantization bit strings may be generated in a low-band subband.

The first electronic device 101 may configure the bitstream to include the quantization bit strings generated by performing quantization for each division audio signal in operation 560. The first electronic device 101 may transmit the bitstream to the second electronic device 102. The first electronic device 101 may transmit the bitstream to the second electronic device 102 through a communication module (e.g., the communication module 190 of FIG. 1). The first electronic device 101 may transmit the bitstream in a Bluetooth scheme through a wireless communication module (e.g., the wireless communication module 192 of FIG. 1).

The first electronic device 101 may establish a radio channel with the second electronic device 102 through the wireless communication module 192. The first electronic device 101 may transmit the bitstream to the second electronic device 102 through the established radio channel. The first electronic device 101 may transmit the bitstream to the second electronic device 102 through, e.g., an advanced audio distribution profile (A2DP).

Although not illustrated, if the first electronic device 101 is connected to the second electronic device 102 through the radio channel, the first electronic device 101 may share information necessary for quantizing or inverse-quantizing the audio signal. Each of the shared information may be synchronized so that quantization or inverse-quantization of the audio signal may be easily performed. For example, the first electronic device 101 may share the second bit allocation table used to perform quantization of the audio signal with the second electronic device 102. The second electronic device 102 may perform inverse-quantization for each division audible frequency band using the shared second bit allocation table.

Each operation illustrated in FIG. 5 is not limited to the illustrated order, but the order may be changed as necessary. For example, the operation in which the first electronic device 101 establishes the radio channel with the second electronic device 102 may be performed before operation 560.

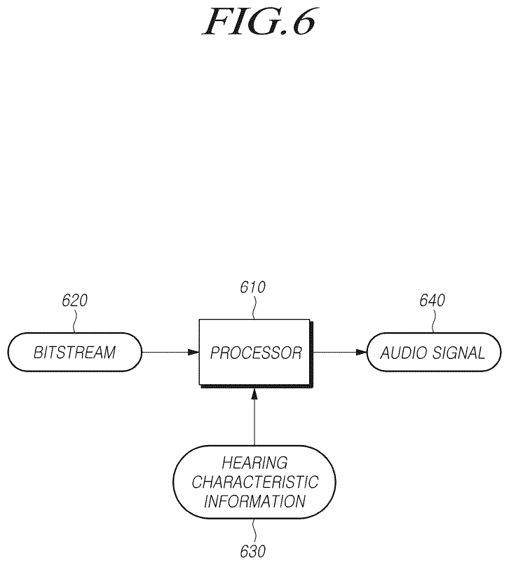

FIG. 6 is a block diagram illustrating a second electronic device according to an embodiment of the disclosure.

Referring to FIG. 6, the second electronic device 102 may reconstruct a bitstream 620 (e.g., the bitstream 340 of FIG. 3) received from the first electronic device 101 to an audio signal 640.

The second electronic device 102 may include, e.g., a sound output device, such as a speaker or an earphone. The second electronic device 102 may be wiredly or wirelessly connected to the first electronic device 101. The second electronic device 102 may be wiredly connected through, e.g., a connection terminal (e.g., the connection terminal 178 of FIG. 1) provided in the first electronic device 101. The second electronic device 102 may be wirelessly connected to the first electronic device 101 through, e.g., a Bluetooth scheme. If the second electronic device 102 is connected to the first electronic device 101 through a radio link, the second electronic device 102 may share information necessary for quantization or inverse-quantization of the audio signal.

The second electronic device 102 may establish a radio channel for connection with the first electronic device 101. The second electronic device 102 may respond to a radio channel establishment request of the first electronic device 101.

A bitstream 620 may be input to the processor 610 included in the second electronic device 102. The bitstream 620 may be a signal obtained by compressing the audio signal 320 (e.g., the audio signal 320 of FIG. 3) through quantization in the first electronic device 101.

The operation performed by the processor 610 may correspond to all or some of the operations performed by the processor 310 (e.g., the processor 310 of FIG. 3) of the first electronic device 101. The processor 610 may, e.g., perform inverse-quantization on the input bitstream 620. The decompression including the inverse-quantization may be performed, e.g., software-wise by the processor 610 or hardware-wise through a separate decoder unit. The processor 610 may be implemented as, e.g., an audio signal processor (e.g., the audio signal processor 240 of FIG. 2).

The processor 610 may analyze information stored in the input bitstream 620. The information stored in the bitstream 620 may include, e.g., information about the hearing measurement result measured by the first electronic device 101 or bit allocation information used when performing quantization on the audio signal. The processor may, e.g., request additional information necessary to perform inverse-quantization on the input bitstream 620 after analyzing the information about the bitstream 620, from the first electronic device 101.

The processor 610 may use the hearing characteristic information 630 in restoring the bitstream 620 to the audio signal. The hearing characteristic information 630 may be, e.g., information reflecting the hearing characteristics of the user. The hearing characteristic information 630 may include, e.g., information measured through the hearing test app of the first electronic device 101. The hearing characteristic information 630 may include, e.g., an average value of a plurality of hearing measurement results or a hearing measurement result most recently measured by the user. The hearing characteristic information 630 may include, e.g., information about a value arbitrarily input by the user for hearing for each frequency band.

For example, the hearing characteristic information 630 may be information stored in the bitstream 620 received from the first electronic device 101. The processor 610 may analyze the received bitstream 620 to obtain hearing characteristic information 630 stored in the bitstream 620. The processor 610 may analyze the received bitstream 620 to obtain bit allocation information used when quantizing the audio signal 320. For example, the hearing characteristic information 630 may be information separately obtained from the first electronic device 101 through the radio channel. For example, the hearing characteristic information 630 may be information stored by the second electronic device 102 in the form of a database.

In the process of restoring the bitstream 620 to the audio signal 640, the processor 610 may perform inverse-quantization on the bitstream 620 received from the first electronic device 101. The inverse-quantization may be performed, e.g., using the bit allocation table used in quantization in the first electronic device 101. The processor 610 may select or generate a bit allocation table to be used for inverse-quantization. The bit allocation table may include, e.g., the first bit allocation table or the second bit allocation table.

For example, if hearing data is present in the second electronic device 102, the bitstream 620 may be inverse-quantized using the bit allocation table (e.g., the characteristic bit allocation table of FIG. 3) reflecting the hearing data and reconstructed to the audio signal 640. If the hearing data is not present in the second electronic device 102, the second electronic device 102 may request the hearing data from the first electronic device 101. If the second electronic device 102 receives hearing data from the first electronic device 101, the second electronic device 102 may generate a first bit allocation table. The second electronic device 102 may request information about the bit allocation table used by the first electronic device 101 to quantize the audio signal 320.

For example, if hearing data is not present in the second electronic device 102 or the hearing data is not received even though the hearing data is requested from the first electronic device 101, the bitstream 620 may be inverse-quantized using the second bit allocation table (e.g., the second bit allocation table in FIG. 3) and reconstructed to the audio signal 640. The standard bit allocation table may be information stored in the memory by the second electronic device 102 or information received by the first electronic device 101.

The processor 610 may select either the first bit allocation table or the second bit allocation table to perform inverse-quantization using the inverse-quantization bit number corresponding to the bitstream 620 for each audible frequency band. If inverse-quantization is performed for each division audible frequency band and then synthesized as one signal, an audio signal 640 may be generated.

The generated audio signal 640 may be, e.g., an audio signal modulated by a pulse code modulation scheme. The audio signal 640 may be converted into an analog signal in an audio module provided in the second electronic device 102 and then output through a voice output device.

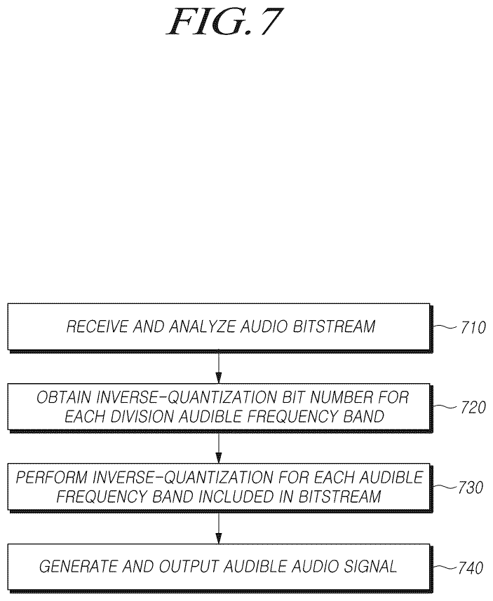

FIG. 7 is a flowchart illustrating control for inverse-quantizing an audio signal by a second electronic device according to an embodiment of the disclosure.

Referring to FIG. 7, in operation 710, the second electronic device 102 may analyze a bitstream received from the first electronic device 101. The second electronic device 102 may receive the bitstream through the radio channel established with the first electronic device 101.

Information that the second electronic device 102 may obtain by analyzing the bitstream may be referred to as ‘bitstream analysis information’. The bitstream analysis information may include, e.g., information about the quantization bit number used when the first electronic device 101 compresses the audio signal. The bitstream analysis information may include, e.g., the bit allocation table used when the first electronic device 101 compresses the audio signal. The bitstream analysis information may include, e.g., hearing measurement information for each division audible band of the user required to generate the bit allocation table.

In operation 720, the second electronic device 102 may obtain the inverse-quantization bit number for each division audible frequency band included in the bitstream. The inverse-quantization bit number for each division audible frequency band may correspond to, e.g., the quantization bit number for each division audible frequency band used when the first electronic device 101 performs compression for each division audio signal.

In operation 730, the second electronic device 102 may perform inverse-quantization on the bitstream for each audible frequency band using the obtained inverse-quantization bit number. For example, the inverse-quantization may be sequentially performed on division audio signals for each audible frequency band included in the bitstream. The inverse-quantization may be performed using, e.g., a first bit allocation table reflecting the user's hearing characteristics or a second bit allocation table not reflecting the user's hearing characteristics. As a result of performing the inverse-quantization, an audio signal may be obtained. The audio signal may be, e.g., a signal modulated by a pulse code modulation scheme. The audio signal may be, e.g., an audio signal generated by the first electronic device 101 as a signal of a music player.

The second electronic device 102 may output the generated audio signal in operation 740. The second electronic device 102 may synthesize the division audio signals for the inverse-quantized bitstream for each division frequency band as one audio signal. Since the synthesized audio signal of the pulse code modulation scheme is a digital audio signal, it may be converted into an analog signal through a digital signal processing unit or a digital to analog converter (DAC) module provided in the second electronic device 102. The audio signal converted into the analog signal may be output to a sound output device provided in the second electronic device 102.

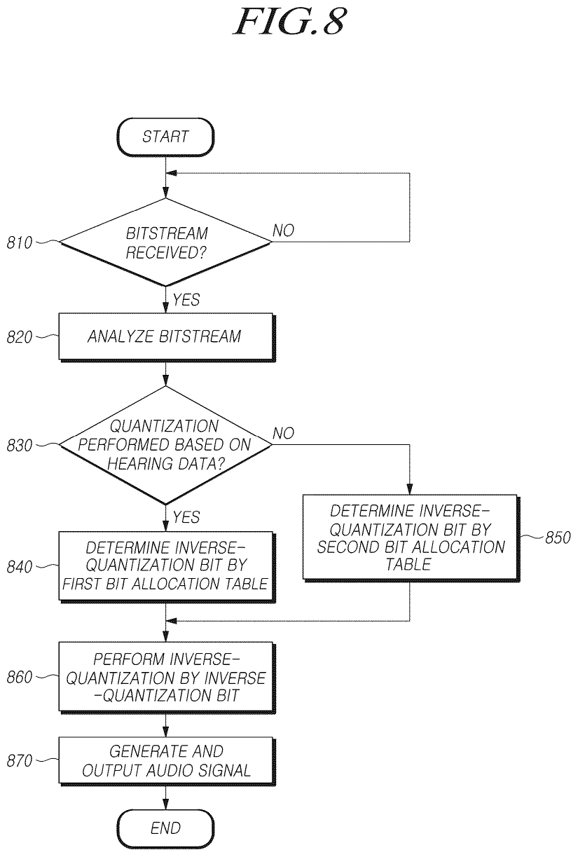

FIG. 8 is a flowchart illustrating control performed for a second electronic device to decompress an audio signal according to an embodiment of the disclosure.

Referring to FIG. 8, in operation 810, the second electronic device 102 may receive a bitstream from the first electronic device 101. The second electronic device 102 may establish a radio channel with the first electronic device 101 through a communication module, or may be wirelessly connected by approving a radio channel establishment request from the first electronic device 101. The second electronic device 102 may receive a bitstream from the first electronic device 101 through a radio channel established with the first electronic device 101.

Although not illustrated, if the second electronic device 102 is connected to the first electronic device 101 for the first time, information necessary for audio signal quantization or inverse-quantization may be shared with each other.

The information may include, e.g., data for the second bit allocation table that does not reflect the hearing characteristics of the user. The information may include, e.g., data indicating the weight capable of generating a first bit allocation table for each division audible frequency.

In operation 820, the second electronic device 102 may analyze information about the received bitstream. The second electronic device 102 may analyze the meta information included in the bitstream. The meta information may include information to be referenced for inverse-quantization of the bitstream.

For example, the meta information may include a first identifier indicating whether the bitstream is generated by quantization considering the hearing data. When the meta information includes the first identifier, the second electronic device 102 may determine the inverse-quantization bit number to be used for inverse-quantization of quantization data for each division frequency band included in the bitstream using the first bit allocation table that it has. For example, the first identifier may be constituted of one bit value (1 bit). When the bit value corresponding to the first identifier is ‘1’, the second electronic device 102 may recognize that the bitstream is generated by quantization considering hearing data. If the bit value corresponding to the first identifier is ‘0’, the second electronic device 102 may recognize that the bitstream is generated by quantization irrelevant to hearing data.

For example, the meta information may include information about the first bit allocation table applied to quantize the bitstream. The information about the first bit allocation table may include, e.g., a second identifier indicating the first bit allocation table used for quantization by the encoder. If the information about the first bit allocation table includes the second identifier, the second electronic device 102 may determine the first bit allocation table used for inverse-quantization among one or more first bit allocation tables, which it uses, using the second identifier. The second electronic device 102 may determine the inverse-quantization bit number to be used for inverse-quantization of quantization data for each division frequency band included in the bitstream using the determined first bit allocation table.

For example, the meta information may include information about the first bit allocation table applied to quantize the bitstream. The information about the first bit allocation table may be, e.g., data capable of constructing the first bit allocation table. If the information about the first bit allocation table includes data capable of constructing the first bit allocation table, the second electronic device 102 may generate the first bit allocation table using the data. The second electronic device 102 may determine the inverse-quantization bit number to be used for inverse-quantization of quantization data for each division frequency band included in the bitstream using the generated first bit allocation table.

For example, the second electronic device 102 may analyze information about the transmission environment included in the bitstream. The transmission environment may analyze, e.g., information about whether reception of the wireless signal or the bitstream transmitted/received through the radio channel between the first electronic device 101 and the second electronic device 102 is smooth. According to the transmission environment analyzed by the first electronic device 101 or the second electronic device 102, the capacity of the bitstream to be transmitted by the first electronic device 101 to the second electronic device 102 may be determined. For example, if the transmission environment is smooth, the capacity of the bitstream that the first electronic device 101 should transmit to the second electronic device 102 may be relatively small. For example, if the transmission environment is not smooth, the capacity of the bitstream that the first electronic device 101 should transmit to the second electronic device 102 may be relatively large.

In operation 830, the second electronic device 102 may analyze the meta information about the received bitstream to determine whether the bitstream has been generated through quantization considering hearing data.

If the bitstream is generated by the quantization bit number considering hearing data, in operation 840, the second electronic device 102 may determine the inverse-quantization bit number to perform inverse-quantization for each division audio signal included in the bitstream for each division audible frequency band by using the first bit allocation table.

If the bitstream is generated by the quantization bit number irrelevant to the hearing data, in operation 850, the second electronic device 102 may determine the inverse-quantization bit number to perform inverse-quantization for each division audio signal included in the bitstream for each division audible frequency band by using the second bit allocation table.

In operation 860, the second electronic device 102 may perform inverse-quantization for each division audio signal included in the bitstream for each division audible frequency band using the bit number to perform inverse-quantization determined for each division audible frequency band.

In operation 870, the second electronic device 102 may generate an audio signal by division audio signals obtained for each division audible frequency band as a result of performing inverse-quantization. The second electronic device 102 may synthesize the division audio signals obtained by performing inverse-quantization for each division audible frequency band. The second electronic device 102 may output the audio signal synthesized for each division audible frequency band. The audio signal may be converted into an analog audio signal and output to the sound output device provided in the second electronic device 102.

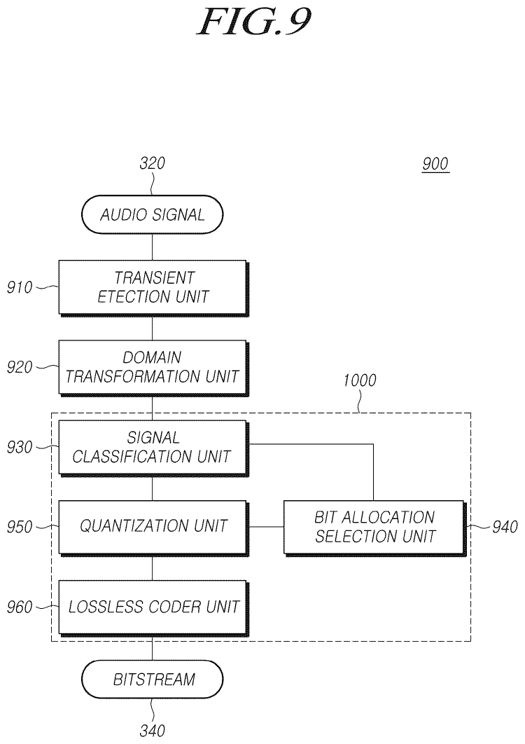

FIG. 9 is a block diagram illustrating an encoder 900 of a first electronic device according to an embodiment of the disclosure.

Referring to FIG. 9, the encoder 900 may include a transient detection unit 910, a domain transformation unit 920, a signal classification unit 930, a bit allocation selection unit 940, a quantization unit 950, and a lossless coder unit 960. Each component may be integrated into at least one module and implemented as at least one processor (e.g., the processor 310 of FIG. 3). Further, each of the above components may be added or omitted as necessary.

The transient detection unit 910 may, e.g., analyze the input audio signal 320 to detect a section representing a transient characteristic, and generate transient signaling information for each frame corresponding to the detection result. The audio signal may be generated, e.g., by executing the music player of the first electronic device 101. The transient detection unit 910 may first determine whether the frame is a transient frame, and secondarily perform verification on the current frame determined as the transient frame. The transient signaling information may be included in a bitstream through a multiplexing unit (not illustrated), and may be provided to the domain transformation unit 920.

The domain transformation unit 920 may determine a window size used for transformation according to the detection result of the transient section, and perform time-frequency transformation based on the determined window size. The transformation may be performed using, e.g., a Fourier transform scheme. For example, the Fourier transform scheme may include discrete Fourier transform (DFT) or fast Fourier transform (FFT).

For example, a short window may be applied to a subband where a transient section is detected, and a long window may be applied to a subband where a transient section is not detected. Alternatively, a short window may be applied to a frame including a transient section.

The signal classification unit 930 may divide the audio signal in the frequency domain into division audible frequency bands of predetermined intervals. The audible frequency bands divided at predetermined intervals may be referred to as subbands. The predetermined intervals may be, e.g., intervals obtained by dividing the audible frequency bands by n. For example, if the audible frequency band is divided into n subbands, the first subband (Sb #1), the second subband (Sb #2), and the like in the order of the high-frequency band from the low-frequency band . . . . Alternatively, it may be referred to as an nth subband Sb #n. The respective intervals of the subbands may be the same or different. For example, the n division subbands may be arranged consecutively in the frequency domain. The n subbands may be arranged in series in the order from the lowest-band subband to the highest-band subband.

The bit allocation selection unit 940 may allocate the quantization bit number for each subband. The bit allocation selection unit 940 may allocate the quantization bit number to each frequency band within a limit that the quantization noise present when quantization is performed according to a masking threshold computed by the processor 120 does not exceed the masking threshold.

The bit allocation selection unit 940 may allocate the quantization bit number for each division audible frequency band by selecting, e.g., a bit allocation table. The bit allocation table may include, e.g., the first bit allocation table or the second bit allocation table.

The first bit allocation table may be, e.g., a bit allocation table considering the hearing characteristics of the user. For example, if the user is sensitive to a high-band as a result of the hearing measurement, the first bit allocation table may be a table where a relatively large quantization bit number is allocated to a high-band frequency. For example, if the user is sensitive to a mid-band as a result of the hearing measurement, the first bit allocation table may be a table where a relatively large quantization bit number is allocated to a mid-band frequency. For example, if the user is sensitive to a low-band as a result of the hearing measurement, the first bit allocation table may be a table where a relatively large quantization bit number is allocated to a low-band frequency.

The second bit allocation table may be, e.g., a table where a relatively large bit number is allocated to a division audible frequency band where statistically many people sensitively react. For example, statistically, in many cases, many people sensitively react to low-band frequencies, so that the second bit allocation table may be a table where a relatively large quantization bit number is allocated to a low-band.

If the bit allocation selection unit 940 allocates the bit number by the first bit allocation table, the quantization bit number may be allocated in the following manner. First, the bit allocation selection unit 940 may allocate the quantization bit number using a Norm value in each subband unit. The Norm value may be a value indicating energy for each subband. For example, if it is most sensitive to the nth subband Sb #n and is most insensitive to the first subband Sb #1 in inverse order, the bit allocation selection unit 940 may give the most weight to the nth subband Sb #n and the least weight to the first subband Sb #1. The bit allocation selection unit 940 may sequentially allocate the quantization bit numbers from the subband having the largest Norm value. In other words, the largest quantization bit number may be allocated to the nth subband Sb #n having the highest priority and, by reducing as many bits as allocated to the nth subband Sb #n from the total allocation bit number, as large a quantization bit number as the corresponding weight may be allocated to the subband having the next highest priority. By repeating such a process, bits may be repeatedly allocated until the total number of bits is exhausted.

The bit allocation selection unit 940 may limit the bit number allocated to each subband not to exceed an allowed bit number (e.g., the total number of bits to be transmitted), determining the quantization bit number to be finally allocated. The quantization bit number to be allocated may be affected, e.g., by a communication environment between the first electronic device 101 and the second electronic device 102.

The quantization unit 950 may quantize the audio signal by the quantization bit number allocated for each subband according to the bit allocation table selected by the bit allocation selection unit 940. The quantization unit 950 may perform quantization through a computation according to the quantization bit number allocated for each subband. The quantization unit 950 may perform quantization on the corresponding division audio signal by the quantization bit number for each subband.

The quantization unit 950 may quantize the Norm value for each subband. In this case, the Norm value may be quantized in various ways, such as vector quantization, scalar quantization, trellis coded quantizer (TCQ), and lattice vector quantization (LVQ). The quantization unit 950 may additionally perform lossless encoding to enhance additional encoding efficiency.

The lossless coder unit 960 may perform lossless encoding on the result quantized by the quantization unit 950. For example, a trellis coded quantizer (TCQ), a uniform scalar quantizer (USQ), a factorial pulse coder (FPC), an analog vector quantizer (AVQ), a predictive vector quantizer (PVQ), or a combination thereof, and the lossless coder unit 960 corresponding to each quantization unit 950 may be used. Further, various encoding techniques may be applied according to the environment where the corresponding codec is mounted or to the needs of the user. Information about the audio signal encoded by the lossless coder unit 960 may be included in the bitstream 340.

The lossless coder unit 960 may hierarchically perform lossless encoding on the audio signal quantized by the quantization unit 950. The lossless coder unit 960 may, e.g., perform lossless encoding with a group of codes corresponding to the highest bits as the highest layer, and sequentially perform lossless encoding with a group of codes corresponding to the lower bits as the lower layers. The lossless coder unit 960 may perform encoding on the audio signal considering, e.g., duplicate values and frequency for each subband.

The bitstream 340 encoded by the lossless coder unit 960 may be transmitted to the second electronic device 102.

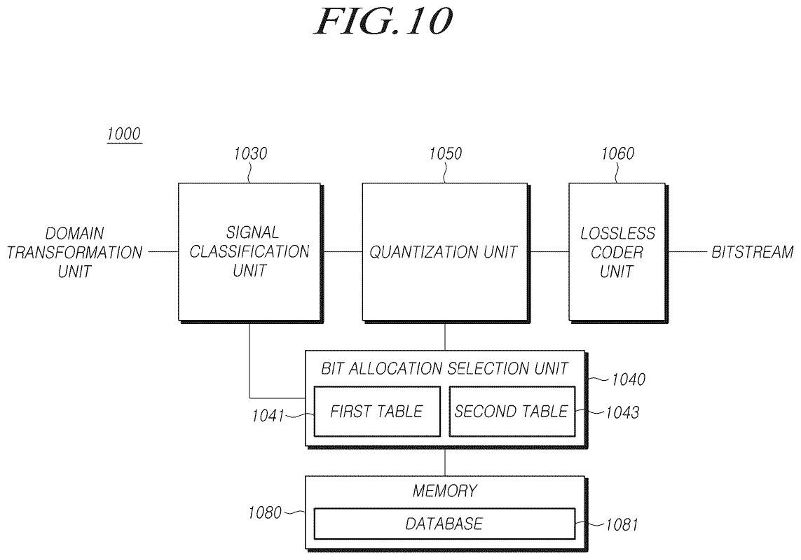

FIG. 10 is a block diagram illustrating part 1000 of an encoder of a first electronic device according to an embodiment of the disclosure.

Referring to FIG. 10, parts related to the disclosure in the encoder of FIG. 9 are illustrated. Accordingly, all or some of the components of FIG. 10 may correspond to the components of FIG. 9. No duplicate description of the components is given below.

The audio signal transformed into the frequency domain in the domain transformation unit 1020 may be input to the signal classification unit 1030. The signal classification unit 1030 may correspond to the signal classification unit (e.g., the signal classification unit 930 of FIG. 7). In the signal classification unit 1030, the audio signal may be divided for each predetermined division audible frequency band for the input audio signal. For example, the audio signal may be divided into n subbands including a first subband Sb #1, a second subband Sb #2, a third subband Sb #3, . . . , an nth subband Sb #n. As an example, the n division subbands may be continuously arranged in the frequency domain. The n subbands may be arranged in series in the order from the lowest-band subband to the highest-band subband.

The hearing data (e.g., the hearing data of FIG. 3) may be stored in the memory 1080 in the form of a database 1081. The hearing data may be represented by Table 1.

| | hearing measurement result | weight assigned |
|---|---|---|
| Subband (Sb) | (hearing loss) | (weight) |
| first subband | very good/good/average | wₐ/w_{b}/w_{c} (w#1) |
| (Sb #1) | (HL #1) | |
| second subband | very good/good/average | wₐ/w_{b}/w_{c} (w#2) |
| (Sb #2) | (HL #2) | |
| third subband | very good/good/average | wₐ/w_{b}/w_{c} (w#3) |
| (Sb #3) | (HL #3) | |
| . . . | . . . | . . . |
| nth subband | very good/good/average | wₐ/w_{b}/w_{c} (w#n) |
| (Sb #n) | (HL #n) | |

Table 1 is a table in which the audible frequency band is divided into n subbands Sb, and hearing measurement results according to each subband Sb are summarized. The hearing measurement result (hearing loss) for each subband may be recorded through the hearing measurement app (e.g., the hearing measurement app of FIG. 3). The hearing measurement result may indicate any one of ‘very good,’ ‘good,’ or ‘average.’ The hearing measurement result of the first subband Sb #1 may be represented as HL #1, the hearing measurement result of the second subband Sb #2 may be represented as HL #2, the hearing measurement result of the third subband Sb #3 may be represented as HL #3, and the hearing measurement result of the nth subband Sb #n may be represented as HL #n.

A different weight may be set according to the hearing measurement result for each subband. The weight may be determined according to the hearing measurement result (hearing loss). For example, when the hearing measurement result is ‘very good,’ a weight of wₐ may be determined. For example, when the hearing measurement result is ‘good,’ a weight of w_{b} may be determined. For example, when the hearing measurement result is ‘average,’ a weight of w_{c} may be determined. wₐ, w_{b}, and w_{c} may have a relationship: wₐ≥w_{b}≥w_{c}.

The user may, by himself/herself, input the hearing measurement result for each of his/her division audible frequencies without performing hearing measurement.

According to the hearing measurement result, hearing data considering the hearing characteristics for each user may be stored, as a database 1081, in the memory 1080.

The processor (e.g., the processor 310 of FIG. 3) may generate a characteristic bit allocation table considering hearing data. Table 2 shows that the processor 310 generates a characteristic bit allocation table by reflecting hearing data.

TABLE 2

| | basis bit | | characterized bit |
|---|---|---|---|
| | allocation value | | allocation value |
| | (basis bit | weight assigned | (characterized bit |
| Subband (Sb) | allocation value) | (weight) | allocation value) |
| first subband | A₁ | wₐ/w_{b}/w_{c} (w#1) | A₁′ |
| (Sb #1) | | | |
| second subband | A₂ | wₐ/w_{b}/w_{c} (w#2) | A₂′ |
| (Sb #2) | | | |
| third subband | A₃ | wₐ/w_{b}/w_{c} (w#3) | A₃′ |
| (Sb #3) | | | |
| . . . | . . . | . . . | . . . |
| nth subband | Aₙ | wₐ/w_{b}/w_{c} (w#n) | Aₙ′ |
| (Sb #n) | | | |

Table 2 is a table in which the frequency band is divided into m subbands Sb, a weight is assigned to the basic bit allocation value for each subband according to the hearing measurement result of each subband Sb to derive a characteristic allocation bit value (characterized bit allocation value). Unlike in Table 1 where the audible frequency band is divided into n subbands, in Table 2, the audible frequency band may be divided into m subbands. m and n may be the same or different. The table constituted of the characteristic allocation bit values may be referred to as a first bit allocation table.

The weight for each subband Sb may be determined as any one value among wₐ, w_{b}, or w_{c} according to the hearing characteristics of the user.

The characteristic allocation bit value (characterized bit allocation value) may be derived by assigning a weight for each subband Sb according to the user's hearing measurement result to each basic bit allocation value for each subband Sb. The characteristic allocation bit value (characterized bit allocation value) may be, e.g., a result derived by multiplying the bit allocation value by the weight. However, without limitations thereto, the characteristic allocation bit value may be derived by performing computation on the bit allocation value and the weight in variously defined manners.

For example, although A₁ and A3 which are the basic bit allocation values of the first subband Sb #1 and the second subband Sb #2 are the same value, if the hearing measurement result HL #1 of the first subband Sb #1 is recorded as ‘very good’ and the hearing measurement result HL #2 of the second subband Sb #2 is recorded as ‘average,’ the respective characteristic bit allocation values A₁′ and A₃′ may be generated to have a relationship: A₁′≥A₃′.

The data in which the characteristic bit allocation values for each subband are summarized as a table may be referred to as a first bit allocation table. The generated first bit allocation table may be stored in the form of a database 1081 in the memory 1080. The processor 310 may generate a plurality of first allocation tables by computation, as necessary.

TABLE 3

| | basic bit | | normalized bit |
|---|---|---|---|
| | allocation | weight assigned | allocation |
| Subband (sb) | value | (weight) | value |
| first subband (Sb #1) | A₁ | wₐ/w_{b}/w_{c} (w#1) | A₁″ |
| second subband (Sb #2) | A₂ | wₐ/w_{b}/w_{c} (w#2) | A₂″ |
| third subband (Sb #3) | A₃ | wₐ/w_{b}/w_{c} (w#3) | A₃″ |
| . . . | . . . | . . . | . . . |
| nth subband (Sb #n) | Aₙ | wₐ/w_{b}/w_{c} (w#n) | Aₙ″ |

Table 3 is a table in which the frequency band is divided into m subbands Sb, a weight is assigned to the basic bit allocation value for each subband according to the hearing measurement result of each subband Sb to derive a standard allocation bit value (normalized bit allocation value). The table constituted of the standard allocation bit values may be referred to as a second bit allocation table.

The weight for each subband Sb may be predetermined as any one value among wₐ, w_{b}, or w_{c} regardless of the hearing characteristics of the user.

The standard allocation bit value (characterized bit allocation value) may be derived by assigning a predetermined weight for each subband Sb according to the user's hearing measurement result to each basic bit allocation value for each subband Sb. The standard allocation bit value (characterized bit allocation value) may be, e.g., a result derived by multiplying the basic bit allocation value by the weight. However, without limitations thereto, the characteristic allocation bit value may be derived by performing computation on the bit allocation value and the weight in variously defined manners.

For example, although A₁ and A3 which are the basic bit allocation values of the first subband Sb #1 and the second subband Sb #2 are the same value, if the hearing measurement result HL #1 of the first subband Sb #1 is pre-stored as ‘very good’ and the hearing measurement result HL #2 of the second subband Sb #2 is pre-stored as ‘average,’ the respective characteristic bit allocation values A₁″ and A₃″ may be generated to have a relationship: A₁″≥A₃″.

The data in which the standard bit allocation values for each subband are summarized as a table may be referred to as a second bit allocation table. The generated second bit allocation table may be stored in the form of a database 1081 in the memory 1080. The processor 310 may generate a plurality of second allocation tables by computation, as necessary.

The bit allocation selection unit 1040 may correspond to the bit allocation selection unit 940 of FIG. 9. The bit allocation selection unit 1040 may select any one of the bit allocation tables depending on the presence or absence of hearing data. The bit allocation table may include a first table 1041 or a second table 1043. The first bit allocation table may be referred to as the first table 1041. The second bit allocation table may be referred to as the second table 1043.

The bit allocation selection unit 1040 may select a bit allocation table by comparing the first table 1041 and the second table 1043 as well as the presence or absence of hearing data. For example, if there is no significant difference between the first table 1041 generated by reflecting hearing characteristics and the second table 1043, which is the standard bit allocation table that does not reflect hearing characteristics, the bit allocation selection unit 1040 may determine the quantization bit number using the second table 834. This takes into account the data efficiency, and the computation efficiency required for quantization.

The quantization unit 1050 may correspond to the quantization unit 950 of FIG. 9. The quantization unit 1050 may perform quantization for each subband Sb according to the bit allocation table selected by the bit allocation selection unit 1040. The quantization bit number may be determined according to the bit allocation value for each subband Sb indicated by the bit allocation table selected by the bit allocation selection unit 1040. The quantization unit 1050 may perform quantization on the corresponding division audio signal by the quantization bit number for each subband.

The lossless coder unit 1060 may correspond to the lossless coder unit 960 of FIG. 9. The lossless coder unit 1060 may perform lossless encoding on a result quantized by the quantization unit 1050. The lossless coder unit 1060 may perform lossless encoding on the corresponding division audio signal quantized for each subband.

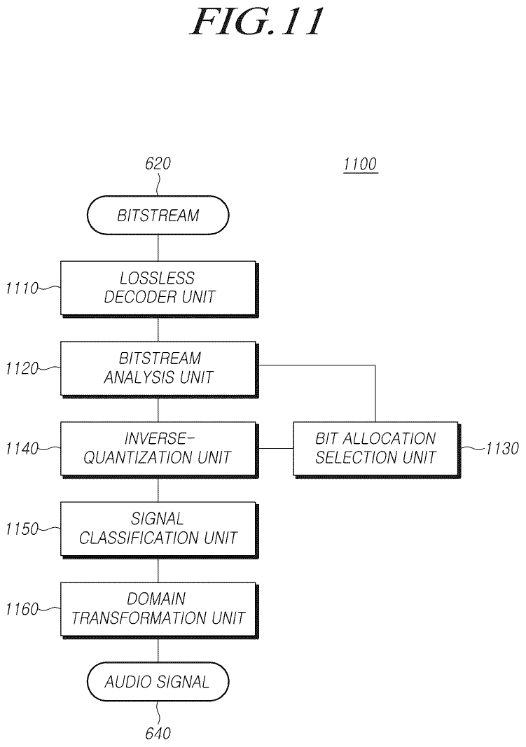

FIG. 11 is a block diagram illustrating a decoder 1100 of a second electronic device according to an embodiment of the disclosure.

Referring to FIG. 11, the decoder 1100 may include a lossless decoder unit 1110, a bitstream analysis unit 1120, a bit allocation selection unit 1130, an inverse-quantization unit 1140, a signal classification unit 1150, and a domain transformation unit 1160. Each component may be integrated into at least one module and implemented as at least one processor (e.g., the processor 610 of FIG. 6). Further, each of the above components may be added or omitted as necessary.

The lossless decoder unit 1110 may hierarchically perform lossless decoding on the bitstream 620 received from the first electronic device 101. The lossless decoder unit 1110 may, e.g., perform lossless decoding with a group of codes corresponding to the highest bits as the highest layer, and sequentially perform lossless decoding with a group of codes corresponding to the lower bits as the lower layers.

The lossless decoder unit 1110 may perform lossless decoding in the manner used by the lossless coder unit (e.g., the lossless coder unit 1160 of FIG. 7).

The bitstream analysis unit 1120 may analyze the received bitstream 620. The bitstream analysis unit 1120 may analyze the meta information included in the bitstream. The meta information may include information to be referenced to inverse-quantize the bitstream 620.

For example, the meta information may include a first identifier indicating whether the bitstream 620 is generated by quantization considering the hearing data. When the meta information includes the first identifier, the second electronic device 102 may determine the inverse-quantization bit number to be used for inverse-quantization of quantization data for each division frequency band included in the bitstream 620 using the first bit allocation table that it has. For example, the first identifier may be constituted of one bit value (1 bit). When the bit value corresponding to the first identifier is ‘1’, the second electronic device 102 may recognize that the bitstream 620 is generated by quantization considering hearing data. If the bit value corresponding to the first identifier is ‘0’, the second electronic device 102 may recognize that the bitstream 620 is generated by quantization irrelevant to hearing data.

For example, the meta information may include information about the first bit allocation table applied to quantize the bitstream 620. The information about the first bit allocation table may include, e.g., a second identifier indicating the first bit allocation table used for quantization by the encoder (e.g., the encoder 900 of FIG. 9). If the information about the first bit allocation table includes the second identifier, the second electronic device 102 may determine the first bit allocation table used for inverse-quantization among one or more first bit allocation tables, which it uses, using the second identifier. The second electronic device 102 may determine the inverse-quantization bit number to be used for inverse-quantization of quantization data for each division frequency band included in the bitstream 620 using the determined first bit allocation table.

For example, the meta information may include information about the first bit allocation table applied to quantize the bitstream 620. The information about the first bit allocation table may be, e.g., data capable of constructing the first bit allocation table. If the information about the first bit allocation table includes data capable of constructing the first bit allocation table, the second electronic device 102 may generate the first bit allocation table using the data. The second electronic device 102 may determine the inverse-quantization bit number to be used for inverse-quantization of quantization data for each division frequency band included in the bitstream 620 using the generated first bit allocation table.

For example, the bitstream analysis unit 1120 may analyze whether there is an error in the bitstream received from the first electronic device 101. For example, if there is an error in the bitstream received from the first electronic device 101 or the transmission environment is not smooth, the second electronic device 102 may request retransmission of the bitstream from the first electronic device 101. The retransmission may be, e.g., a scheme according to a transmission control protocol (TCP) retransmission scheme. The retransmission may be requested by adopting at least one of time-based retransmission, explicit retransmission feedback, or a fast retransmission scheme.

The bit allocation selection unit 1130 may determine which bit allocation table to perform inverse-quantization on the bitstream for each frequency band. For example, the bit allocation selection unit 1130 may select one of the first bit allocation table or the second bit allocation table.

The bit allocation selection unit 1130 may compare the first bit allocation table or the second bit allocation table and then determine which bit allocation table is to be used to perform inverse-quantization. For example, If the second electronic device 102 has both the first bit allocation table and the second bit allocation table in the memory, if the two tables are not different by a threshold level, the bit allocation selection unit 1130 may perform inverse-quantization by selecting the standard bit allocation table. The threshold level may mean, e.g., a case where a difference in the bit allocation number for each subband is 1% or more of the total number of bits to be allocated. However, this is merely a value, and the threshold level may be set differently considering the circumstance.

The inverse-quantization unit 1140 may inversely quantize the bitstream by the bit number allocated for each subband using the bit allocation table selected by the bit allocation selection unit 1130. The inverse-quantization unit 1140 may perform inverse-quantization in the same manner as the quantization unit (e.g., the quantization unit 1050 of FIG. 10) performs quantization. For example, the inverse-quantization unit 1140 may perform inverse-quantization on each audio signal included for each division audible frequency band using either the first bit allocation table or the second bit allocation table.

The signal classification unit 1150 may subdivide division audio signals obtained for each division frequency band as a result of performing inverse-quantization, for each subband. The signal classification unit 1150 may divide, e.g., partitions for each subband for the bitstream. The signal classification unit 1150 may reflect an energy value for each partition when dividing the partitions for each subband. For example, the signal classification unit 1150 may apply a different gain value for each partition.

The domain transformation unit 1160 may transform the area of the bitstream subjected to inverse-quantization. For example, the domain transformation unit 1160 may transform a bitstream of a frequency domain into a time domain. The transformation may be performed using, e.g., an inverse Fourier transform scheme. For example, the inverse fast Fourier transform (IFFT) scheme may include an inverse fast Fourier transform (IFFT). The domain transformation unit 1160 may transform the decoded bitstream into a time domain to generate a reconstructed audio signal.

The domain transformation unit 1160 may synthesize the bitstream inverse-quantized for each division audible frequency.

The audio signal 640 generated through the domain transformation unit 1160 may be transformed into an analog audio signal in a digital signal processor or ADC provided in the second electronic device 102 and then output to the sound output device.

An embodiment of the disclosure may provide a device and method for minimizing quantization noise by reflecting the user's individual hearing characteristics in quantizing or inverse-quantizing an audio signal.

A method for controlling a first electronic device 101 according to an embodiment of the disclosure may comprise an operation 410 of obtaining a quantization bit number for each division audible frequency band dividing an audible frequency band based on a preset user's hearing characteristic, an operation 420 of performing quantization using a quantization bit number corresponding to an audio signal for each division audible frequency band extracted from an audio signal 320 output by reproduction of an audio content, and an operation 430 of generating an audio signal quantized for each division audible frequency band as a bitstream 340 and transmitting the bitstream to the second electronic device 102 through a radio channel.

The method for controlling the first electronic device 101 according to an embodiment of the disclosure may comprise an operation of setting the preset user's hearing characteristic 330 by performing hearing measurement for each division audible frequency band, on a user.

The method for controlling the first electronic device 101 according to an embodiment of the disclosure may comprise an operation 530 of generating a quantization bit allocation table in which the quantization bit number for each division audible frequency band is updated by reflecting the preset user's hearing characteristic 330.

The method for controlling the first electronic device 101 according to an embodiment of the disclosure may comprise an operation 530, 540 of selecting one quantization bit allocation table from among a plurality of generated quantization bit allocation tables.

The method for controlling the first electronic device 101 according to an embodiment of the disclosure may comprise an operation of lossless-encoding the audio signal quantized for each division audible frequency band.

A method for controlling the second electronic device 102 according to an embodiment of the disclosure may comprise an operation 710, 820 of analyzing a bitstream 340, 620 received from the first electronic device 101, an operation 720 of obtaining an inverse-quantization bit number for each division audible frequency band included in the bitstream, an operation 730 of performing inverse-quantization on the bitstream 340, 620 for each audible frequency band using the inverse-quantization bit number, and an operation 740 of outputting an audio signal 640 generated by the inverse-quantization.

In the method for controlling the second electronic device 102 according to an embodiment of the disclosure, the inverse-quantization bit number may correspond to a quantization bit number for each audible frequency band used for the first electronic device 101 to perform quantization on an audio signal 320.

The method for controlling the second electronic device 102 according to an embodiment of the disclosure may comprise an operation of requesting information about a preset user's hearing characteristic 630 required to perform inverse-quantization, from the first electronic device 101.

The method for controlling the second electronic device 102 according to an embodiment of the disclosure may comprise an operation of obtaining the information 630 about the preset user's hearing characteristic present, from a first electronic device 101 and an operation of generating an inverse-quantization bit allocation table for each division audible frequency band from the obtained information 630.

A first electronic device 101 according to an embodiment of the disclosure may comprise at least one processor 120, 310 and a communication module 190. The at least one processor 120, 310 may obtain a quantization bit number for each division audible frequency band dividing an audible frequency band based on a preset user's hearing characteristic 330, perform quantization using a quantization bit number corresponding to an audio signal for each division audible frequency band extracted from an audio signal output by reproduction of an audio content, and generate an audio signal quantized for each division audible frequency band as one bitstream 340 and transmit the bitstream to a second electronic device 102 through a radio channel.

In the first electronic device 101 according to an embodiment of the disclosure, the at least one processor 120, 310 may set the preset user's hearing characteristic 330 by performing hearing measurement for each division audible frequency band, on a user.

In the first electronic device 101 according to an embodiment of the disclosure, the at least one processor 120, 310 may generate a quantization bit allocation table in which the quantization bit number for each division audible frequency band is updated by reflecting the preset user's hearing characteristic 330.

In the first electronic device 101 according to an embodiment of the disclosure, the at least one processor 120, 310 may select one quantization bit allocation table from among a plurality of generated quantization bit allocation tables.

In the first electronic device 101 according to an embodiment of the disclosure, the at least one processor 120, 310 may lossless-encode the audio signal quantized for each division audible frequency band.

A second electronic device 102 according to an embodiment of the disclosure may comprise at least one processor 610 and a communication module. The at least one processor 610 may analyze a bitstream received from a first electronic device 101, obtain an inverse-quantization bit number for each division audible frequency band included in the bitstream 340, 620, perform inverse-quantization on the bitstream 340, 620 for each audible frequency band using the inverse-quantization bit number, and output an audio signal 640 generated by the inverse-quantization.

In the second electronic device 102 according to an embodiment of the disclosure, the inverse-quantization bit number may correspond to a quantization bit number for each audible frequency band used for the first electronic device 101 to perform quantization on an audio signal 320.

The at least one processor 610 of the second electronic device 102 according to an embodiment of the disclosure may request information 330, 630 about a preset user's hearing characteristic required to perform inverse-quantization, from the first electronic device 101.

The at least one processor 610 of the second electronic device 102 according to an embodiment of the disclosure may obtain the information 330 about the preset user's hearing characteristic present, from the first electronic device 101, and generate an inverse-quantization bit allocation table for each division audible frequency band from the obtained information 330, 630.

The electronic device 101, 102 according to an embodiment of the disclosure may select a quantization model considering a communication environment and quantize or inverse-quantize the audio signal 320, 630.

The electronic device 101, 102 according to an embodiment of the disclosure may minimize the quantization noise generated when the audio signal 320, 630 is quantized or inverse-quantized based on the user's hearing data 330, 630, and provide an audio signal with the optimal sound quality.

One or more non-transitory computer-readable storage media storing one or more computer programs according to an embodiment of the disclosure may comprise computer-executable instructions that, when executed by one or more processors of the first electronic device 101 individually or collectively, cause the electronic device to perform operations. The operations may include obtaining a quantization bit number for each division audible frequency band dividing an audible frequency band based on a preset user's hearing characteristic. The operations may include performing quantization using a quantization bit number corresponding to an audio signal for each division audible frequency band extracted from an audio signal output by reproduction of an audio content. The operations may include generating an audio signal quantized for each division audible frequency band as a bitstream and transmitting the bitstream to the second electronic device 102 through a radio channel.

The operations according to an embodiment of the disclosure may further include setting the preset user's hearing characteristic by performing hearing measurement for each division audible frequency band, on a user.

The operations according to an embodiment of the disclosure may further include generating a quantization bit allocation table in which the quantization bit number for each division audible frequency band is updated by reflecting the preset user's hearing characteristic.

The operations according to an embodiment of the disclosure may further include selecting one quantization bit allocation table from among a plurality of generated quantization bit allocation tables.

The operations according to an embodiment of the disclosure may further include lossless-encoding the audio signal quantized for each division audible frequency band.

One or more non-transitory computer-readable storage media storing one or more computer programs according to an embodiment of the disclosure may comprise computer-executable instructions that, when executed by one or more processors of the second electronic device 102 individually or collectively, cause the electronic device to perform operations. The operations may include obtaining an inverse-quantization bit number for each division audible frequency band included in the bitstream. The operations may include performing inverse-quantization on the bitstream for each audible frequency band using the inverse-quantization bit number. The operations may include outputting an audio signal 640 generated by the inverse-quantization.

The operations according to an embodiment of the disclosure, the inverse-quantization bit number may correspond to a quantization bit number for each audible frequency band used for the first electronic device 101 to perform quantization on an audio signal.

The operations according to an embodiment of the disclosure may further include requesting information about a preset user's hearing characteristic required to perform inverse-quantization, from the first electronic device 101.

The operations according to an embodiment of the disclosure may further include obtaining the information about the preset user's hearing characteristic present, from a first electronic device 101.

The operations according to an embodiment of the disclosure may further include generating an inverse-quantization bit allocation table for each division audible frequency band from the obtained information.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for controlling an electronic device, the method comprising:
obtaining a quantization bit number for each division audible frequency band dividing an audible frequency band based on a preset user's hearing characteristic;
performing quantization using a quantization bit number corresponding to an audio signal for each division audible frequency band extracted from an audio signal output by reproduction of an audio content; and
generating an audio signal quantized for each division audible frequency band as a bitstream and transmitting the bitstream to an external electronic device through a radio channel.

2. The method of claim 1, further comprising:
setting the preset user's hearing characteristic by performing hearing measurement for each division audible frequency band, on a user.

3. The method of claim 1, further comprising:
generating a quantization bit allocation table in which the quantization bit number for each division audible frequency band is updated by reflecting the preset user's hearing characteristic; and
selecting one quantization bit allocation table from among a plurality of generated quantization bit allocation tables.

4. The method of claim 1, further comprising:
lossless-encoding the audio signal quantized for each division audible frequency band.

5. A method for controlling an electronic device, the method comprising:
analyzing a bitstream received from an external electronic device;
obtaining an inverse-quantization bit number for each division audible frequency band included in the bitstream;
performing inverse-quantization on the bitstream for each audible frequency band using the inverse-quantization bit number; and
outputting an audio signal generated by the inverse-quantization.

6. The method of claim 5, wherein the inverse-quantization bit number corresponds to a quantization bit number for each audible frequency band used for the external electronic device to perform quantization on an audio signal.

7. The method of claim 5, further comprising:
requesting information about a user's hearing characteristic required to perform inverse-quantization, from the external device.

8. The method of claim 7, further comprising:
obtaining the information about the user's hearing characteristic from the external electronic device; and
generating an inverse-quantization bit allocation table for each division audible frequency band from the obtained information.

9. An electronic device for transmitting an audio signal, the electronic device comprising:
a communication module;
memory storing one or more computer programs; and
one or more processors communicatively coupled to the communication module and the memory,
wherein the one or more computer programs include computer-executable instructions that, when executed by the one or more processors individually or collectively, cause the electronic device to:
obtain a quantization bit number for each division audible frequency band dividing an audible frequency band based on a preset user's hearing characteristic,
perform quantization using a quantization bit number corresponding to an audio signal for each division audible frequency band extracted from an audio signal output by reproduction of an audio content, and
generate an audio signal quantized for each division audible frequency band as one bitstream and transmit the bitstream to an external electronic device through a radio channel.

10. The electronic device of claim 9, wherein the one or more computer programs further include computer-executable instructions that, when executed by the one or more processors individually or collectively, cause the electronic device to set the preset user's hearing characteristic by performing hearing measurement for each division audible frequency band, on a user.

11. The electronic device of claim 9, wherein the one or more computer programs further include computer-executable instructions that, when executed by the one or more processors individually or collectively, cause the electronic device to:
generate a quantization bit allocation table in which the quantization bit number for each division audible frequency band is updated by reflecting the preset user's hearing characteristic, and
select one quantization bit allocation table from among a plurality of generated quantization bit allocation tables.

12. The electronic device of claim 9, wherein the one or more computer programs further include computer-executable instructions that, when executed by the one or more processors individually or collectively, cause the electronic device to lossless-encode the audio signal quantized for each division audible frequency band.

13. An electronic device for outputting an audio signal, the electronic device comprising:
a communication module;
memory storing one or more computer programs; and
one or more processors communicatively coupled to the communication module and the memory,
wherein the one or more computer programs include computer-executable instructions that, when executed by the one or more processors individually or collectively, cause the electronic device to:
analyze a bitstream received from an external electronic device,
obtain an inverse-quantization bit number for each division audible frequency band included in the bitstream,
perform inverse-quantization on the bitstream for each audible frequency band using the inverse-quantization bit number, and
output an audio signal generated by the inverse-quantization.

14. The electronic device of claim 13, wherein the inverse-quantization bit number corresponds to a quantization bit number for each audible frequency band used for the external electronic device to perform quantization on an audio signal.

15. The electronic device of claim 13, wherein the one or more computer programs further include computer-executable instructions that, when executed by the one or more processors individually or collectively, cause the electronic device to:
request information about a user's hearing characteristic required to perform inverse-quantization, from the external electronic device.

16. The electronic device of claim 13, wherein the one or more computer programs further include computer-executable instructions that, when executed by the one or more processors individually or collectively, cause the electronic device to:
obtain information about the user's hearing characteristic from the external electronic device, and
generate an inverse-quantization bit allocation table for each division audible frequency band from the obtained information.
